(19) United States
(12) Patent Application Publication
(10) Pub. No.: US 2023/0249474 A1
(43) Pub. Date: Aug. 10, 2023

(54) LASER PRINTING ON CURVED SURFACES

(71) Applicant: Heliosonic GmbH, Wesel (DE)

(72) Inventors: Udo Lehmann, Wesel (DE); Florian Löbermann, Wesel (DE); Frank Walter, Wesel (DE)

(21) Appl. No.: 18/010,227

(22) PCT Filed: Jun. 8, 2021
(86) PCT No.: PCT/EP2021/065231

§ 371 Date: Dec. 14, 2022

(30) Foreign Application Priority Data
Jul. 1, 2020 (EP) 20183337.3

(51) Int. Cl. B41J 3/407; B41M 5/382; B41M 5/00; B41M 7/00; B41J 2/44

(52) U.S. Cl. CPC B41J 3/4073; B41M 5/38242; B41M 5/0094; B41M 7/009; B41J 2/442

(57) ABSTRACT

The invention relates to a process for printing a substrate (7) containing curved surface sections by using an ink printing assembly with a movable print head (8) comprising an ink carrier (1) having an ink layer, the ink layer being irradiated regionally in such a way that heat bulges are formed in the ink layer which cause the splitting of ink droplets so that the ink printing assembly is working as nozzle-less droplet ejector for ejecting droplets of ink from the ink layer, where the distance between the print head (8) and the curved sections of the substrate (7) is adjusted by moving the print head relative to the substrate by providing the print head with three degrees of freedom in translation, allowing horizontal (Tx), vertical (Tg) and in depth (Tz) translations.

The invention relates to a process for printing on a substrate containing curved surface sections, said so printed substrate and the printing apparatus used.

It is often desired to paint or to print on curved surfaces of objects, in particular on curved automotive surfaces.

In case special printing machines are not available simple spray painting in which the substrate is masked off might provide sufficient results. For this purpose masking tapes for spray painting are used. Where curved edges and three-dimensional surfaces need to be masked, special fineline tapes with a very level of high conformability might be used.

However, often it is difficult to provide such masking tapes which offer good adhesion on relevant substrates on the one hand which can be removed afterwards without leaving any adhesive residues on the other hand. Furthermore, masking of the substrate, e.g. providing the frame of letters on an automotive part, is time consuming and cannot be deemed as to be time efficient. An additional drawback of this method is the non-optimal degree of application efficiency, so that part of the sprayed paint, known as overspray, does not land on the substrate part to be painted but on the masking material.

Thus, often complex printing apparatuses for ink jet printing on curved surfaces of objects are used in order to increase the efficiency. Such apparatuses typically comprise an inkjet printhead having a plurality of nozzles, and there are also such being operative to effect relative movement of the nozzles and the substrate.

US 201102626 and U.S. Ser. No. 10/150,304 propose such a machine type for painting vehicle parts with a paint. Said machine type comprises an application device that applies the coating agent, wherein the application device includes a print head that discharges the coating agent from a plurality of coating agent nozzles included on the print head.

However this complicated machine is not optimal concerning the flexibility of use and efficiency because coating nozzles are needed. The use of coating nozzles generally mean limitations concerning the rheology and the ingredients of the used paint. Generally, it is difficult to print paints of high viscosity or bigger particle containing paints through nozzles. Furthermore, ink nozzles easily become blocked and in case of the change of the ink the nozzles have to be cleaned. This further limits the universal and practical use of such a machine.

The problem addressed by the present invention is therefore that of providing a method of selective printing on curved surfaces of objects. The printing result should be of high quality on the one hand and the printing method should be efficient on the other hand.

The solution to this problem is a process for printing a substrate containing curved surface sections by using an ink printing assembly with a movable print head comprising an ink carrier having an ink layer,

the ink layer being irradiated regionally in such a way that heat bulges are formed in the ink layer which cause the splitting of ink droplets so that the ink printing assembly is working as nozzleless droplet ejector for ejecting droplets of ink from the ink layer, where
the distance between the print head and the curved sections of the substrate is adjusted by moving the print head relative to the substrate by providing the print head with three degrees of freedom in translation, allowing horizontal (Tx), vertical (Tg) and in depth (Tz) translations.

Nozzleless droplet ejection means that no ink nozzles are used according to the relevant printing mechanism.

Having three degrees of freedom in translation, which is used to position the printing assembly by enabling translational movements along horizontal, vertical and depth axes allows the printing with sharp edges on even strongly curved substrates.

The printing process according to the present invention allows to paint or to print with sharp edges on curved surfaces of objects, in particular on curved automotive surfaces. It is not necessary that the relevant substrates are masked off before printing so that the efficiency is increased.

Additional advantage is caused because the printing process according to the present invention avoids the use of printing nozzles. Working nozzleless means to increase the flexibility and the universality of the printing process because e.g. it is possible to print also paints of high viscosity or bigger particle containing paints. Relevant nozzleless printing makes it also easier to change to color of the printed ink.

Additionally, it should be said that formation of satellites around the transferred drop of ink can be avoided.

It should be pointed out that the printing process according to the present invention allows printing with sharp edges also on curved substrates.

Because the new coating process has no nozzles, there is no resolution limitation caused by nozzles. With this technology according to the present invention, inks with high viscosity and large particles can be printed with high print resolution without any problems.

This nozzleless digital printing technology according to the present invention achieves a print resolution of <500 μm or <200 μm or <100 μm of printed dot size in combination with a high coating thickness. The wet coating thickness is >10 μm better >20 μm. The “wet coating thickness” is determined gravimetrically. The “dry coating thickness” is more difficult to measure exactly (e.g. by length measuring via light microscope). The difference between the dry coating thickness (of the final product) and the wet coating thickness (directly after printing) depends on the shrinkage of the ink layer during its drying (removing solvent). In practice the dry coating thickness is typically about 5-50% of the corresponding wet coating thickness.

The relevant high printing quality is also characterized by a low “satellite generating rate” (splashes outside the printed image): The satellite generating rate is determined via microscopical satellite counting (counting number of splashes). The relevant satellite generating rate is less than 5 splashes per mm²: regarded is the distance (as regarded area) between 0 and 1 mm outside the printed image; said distance of 0 mm should be defined as the edge of the printing image; determined is the arithmetic mean (of the satellite generating rate) referring to a corresponding overall reference area of 1 cm²; only splashes are counted which are detectable by light microscope and having at least in one dimension a length of >10 μm. It should be mentioned that smaller splashes generally have only a small influence concerning the printing quality.

Thus, the invention provides a substrate containing curved surface sections which is printed by a process as described above, wherein a satellite generating rate of less than 5 splashes per mm² in combination with a wet coating thickness of >10 μm is achieved.

The printing mechanism of the process according to the present invention:

Typically, the ink layer is heated by means of a laser which regionally heats the ink layer, preferably line by line, through the ink carrier, as a result of which the ink, particularly by virtue of vaporizing constituents, is heated and forms a bulge.

The laser used may in particular be a switched laser. According to one embodiment, the laser generates a grid of dots which forms the printed image. According to another embodiment, the laser runs in lines. Combinations of dots and lines are likewise conceivable.

Summarizing, the ink layer is normally irradiated by means of a laser, more particularly by means of a switched laser.

The ink layer is heated in such a way that the ink particles which form are split off and thrown in the direction of the substrate.

The ink splitting is the process of ink transfer, particularly that in which a drop of ink goes onto the substrate, where it attaches permanently and forms a printed dot or a printed line.

The attachment preferably takes place predominantly, more preferably exclusively, by forces of adhesion between the substrate and the drop of ink that forms.

Also conceivable, however, at least in a supporting function, is to utilize magnetic or electrostatic forces so that the bulge attaches on the substrate and so forms a drop which goes over onto the substrate.

Generally, the ink carrier and ink layer are moved parallel to one another (typically the ink layer lies on a circulating ink ribbon).

Normally, substrate and ink carrier are moved relative to one another at a speed which typically corresponds to about the half of the printing speed.

The printing speed should be defined as to be the number of the scanned printing lines per second, multiplied with the printed line width.

This allows a clean printed image and a high resolution to be achieved.

The positioning of the printing assembly might be additionally supported by means of a special join providing two degrees of freedom in rotation. Then, the print head is typically provided with two degrees of freedom in rotation, which supports and ensures the orientation of the print head by allowing rotations (Rx, Ry) thereof along two perpendicular axes.

A switched laser used is normally designed as a laser working with a single light wavelength but providing variability concerning light intensity and switching frequency.

The ink layer can be formed by coating an ink ribbon with an ink. This may be configured in particular with a circulating ribbon which in order to produce an ink layer is guided through an inking unit, more particularly a nip inking unit.

Said ink layer being in contact with the ink carrier might be (stepless) generated with a variable thickness so that the current amount of the ejected ink is adjustable. The thickness of the ink layer (on the ink ribbon) should be normally >30 μm.

Typically, the current amount of the ejected ink is (stepless) adjustable by variation of the intensity of the irradiation, more particularly by the variation of the laser power.

With the process of the invention it is possible to apply ink layers 1 to 100 μm, preferably 10 to 50 μm, thick to the substrate.

In a preferred embodiment the ink layer comprises absorbing particles and a soluble polymer having a weight average (Mw) molecular weight of greater than 250 000 g/mol, where the weight average (Mw) of the molecular weight of the soluble polymer is determined according to DIN 55672-2: 2016-3.

According to the preferred embodiment of the invention, a soluble polymer having a molecular weight Mw of greater than 250 000 g/mol is added as additive to a solvent of the ink used for the ink layer.

Said weight average (Mw) of the molecular weight is determined according to DIN 55672-2: 2016-3: N,N-dimethylacetamid is used as elution solvent.

Additional practical measuring detail: especially use of PSS-SDV-gel (macroporous styrene-divinylbenzene copolymer network) columns. (More) Especially use of the combination of four PSS-SDV-gel (macroporous styrene-divinylbenzene copolymer network) columns; dimensions: 300 mm*8 mm ID per column; particle size: 5 or 10 μm; pore size: 1*10⁵ Å; 1*10⁴ Å; 1*10³ Å; 1*500 Å.

It has emerged that by adding a polymer which is soluble in the solvent, it is possible to reduce significantly the risk of formation of satellites (splashes).

Without being tied to the theory, this is probably attributable to factors including a greater elasticity on the part of the ink thus modified.

The proportion of the soluble polymer is according to one embodiment of the invention 0.05-2 weight %, of the total ink mixture. The proportion of the soluble polymer is preferably more than 0.05 and/or less than 1 weight %, typically more than 0.1 and/or less than 0.8 weight %, of the total ink mixture.

Preferred soluble polymers are generally such having on the one hand a high molecular weight and being on the other hand soluble in the used solvent.

The soluble polymer used according to one preferred embodiment of the invention comprises a cellulose ester, a cellulose nitrate, a cellulose ether, more particularly a hydroxypropylcellulose, a polyurethane or a vinyl polymer.

Hydroxypropylcellulose in particular, in other words a cellulose ether in which some of the hydroxyl groups are linked as ethers with hydroxypropyl groups, appears particularly suitable for the effect of the invention. However, also other types of soluble polymers might be used, like polyether (e.g. polyethylene glycols), polyacrylates (e.g. polyacrylic acid) or even also natural polymers (e.g. such on the basis of alginates). It should be taken into consideration that an appropriate solvent or solvent mixture has to be chosen in which the relevant polymer is soluble. Typically, (polar) organic solvents might be used (also such being on the basis of monomers, like polymerizable vinylic monomers). However, also water might be an advantageous solvent for special applications.

It has been found that the low-level admixing of soluble polymers in the average molecular weight range from about Mw: 250 000 g/mol to about 1 500 000 g/mol has a positive influence on the print behaviour of the ink.

These admixtures modify what is called the elasticity of the ink. Admixtures of soluble polymers around the lower Mw range (Mw: 10 000 g/mol to approximately 100 000 g/mol) have only a thickening effect and only slight anti-splash properties. Polymers with higher Mw values (>1 500 000 g/mol) lead in contrast to no further improvement in the anti-splash properties, but merely further hinder the solubility. Preference is therefore given to using a polymer having a molecular weight (Mw) below 2 500 000 g/mol, more preferably below 1 500 000 g/mol.

Summarizing, the soluble polymer generally has a weight average (Mw) molecular weight of 250 000 g/mol to 2 500 000 g/mol and preferably the proportion of the soluble polymer accounts for between 0.05 to 2 weight %, of the total ink mixture.

According to a preferred embodiment the absorbing particles contain carbon black or consist of carbon black.

However instead of or in addition to such pure absorbing particles also reflective particles might be used. Such reflective particles should have also adsorbing properties in respect to the laser beam, especially in the wavelength range of the laser used, more particularly in the range of 300 to 3000 nm. However, in contrast to absorption particles like carbon black particles, reflective particles have also reflective properties concerning the visible wavelength spectrum.

Particles which have a high reflection relative to the wavelength of the laser used, more particularly 300 to 3000 nm, might be used.

In contrast to absorption particles known from the prior art, such as carbon black, for example, the reflective particles may be substantially neutral for the coloured impression conveyed by the ink layer.

Particles which can be used are, first, for example, particles of metal or of a metal-coated carrier material. These particles produce reflection on the basis of mirroring surfaces. In particular it is possible to use what are called effect pigments, preferably lustre pigments.

The reflective particles may be added in particular in an amount of more than 1 and/or less than 10 weight % to the ink that is used for the ink layer.

Further, transparent particles can be used which develop a mirroring effect by virtue of total reflections. Particles having an optical interference coating can also be used.

The particle size may be determined by laser diffraction measurement. This can be done using as a measuring instrument, for example, the Shimadzu® SALD-2201 laser size analyser.

In this way, particularly effective absorption can be achieved.

In order to achieve a high reflection effect, particles may be used which have an L* value in the L*a*b* colour space of more than 50, preferably more than 70 and more preferably more than 80.

Further, the particles may be neutral in colour. In one embodiment the particles in the L*a*b* colour space have an a* and/or b* value of +/−30. Use may be made more particularly of particles having an a* and/or b* value in the L*a*b* colour space of less than +/−5, preferably +/−3.

The reflective particles typically have an aspect ratio >50 and normally an average particle thickness P_{T}<80+3 P_{S} (P_{S}: average particle size, value in μm; P_{T} average particle thickness, value in nm).

Often the reflective particles have an aspect ratio >25 and P_{T}<80+3 P_{S}.

The particle size distribution is measured by laser scattering granulometry using a Helos/BR Multirange (Sympatec) apparatus according to the manufacturer indications and in accordance to ISO 13320-1. The particles are dissolved in isopropanol under stirring before measuring the particle size distribution. The particle size function is calculated in the Fraunhofer-approximation as a volume weighted cumulative frequency distribution of equivalent spheres. The median value d50 means that 50% of the measured particles are below this value (in a volume-averaged distribution). The d50 value is taken as the average particle size. The particle diameter is determined using a reflective electron microscope (REM). A resin customarily used in electron microscopy, for example TEMPFIX (Gerhard Neubauer Chemikalien, D-48031 Munster, Germany), is applied to a sample plate and heated to softening on a hotplate. Subsequently, the sample plate is taken from the hotplate and the sample to be measured is scattered onto the softened resin. In the measurement of the thickness, the azimuthal angle α of the pigment is estimated relative to a plane normal to the surface and allowed for when evaluating the thickness according to the formula H_{eff}=Hₘₑₛ/cos α.

The cumulative frequency curve was plotted from the H_{eff} values with the aid of the relative frequencies of occurrence. At least about 100 particles are counted and the average value of H_{eff} is taken as the average particle thickness.

The values in L*a*b* colour space are determined using a DTM 1045® spectrophotometer at an angle between 15 and 25°.

Typically, the ink after printing is dried or thermally cured and/or in that two or more ink layers are applied one above another.

The present invention is also directed to a substrate containing curved surface sections which is printed by a process as described above.

Said substrate might be provided by an automotive part. However, the substrate might be on the basis of any other body type, especially machines (e.g. planes or ships) or machine parts. There is no limitation concerning the relevant material of the substrate body, which might be for example metal, artificial material, stone, paper or wood.

The present invention also relates to a printing apparatus containing a nozzleless droplet ejector, a movable print head and an apparatus for moving said print head to provide three degrees of freedom in translation, allowing horizontal (Tx), vertical (Tg) and in depth (Tz) translations, configured for executing a process as described above.

Typically said apparatus for moving the print head is provided as robot having an arm connected with the print head.

According to a special embodiment the apparatus for moving the print head additionally provides two degrees of freedom in rotation, which supports and ensures the orientation of the print head by allowing rotations (Rx, Ry) thereof along two perpendicular axes

In WO 2019/145300 a print apparatus providing a different ink ejection mechanism is described. Although the general principle of the printing head is similar it can be only used for printing on flat surfaces. Showing the contrast to said printing apparatus in practice below it should be illustrated by the drawing how the printing apparatus according to the present invention works.

The drawing shows in

FIG. 1 a schematic cross section through the printing head,

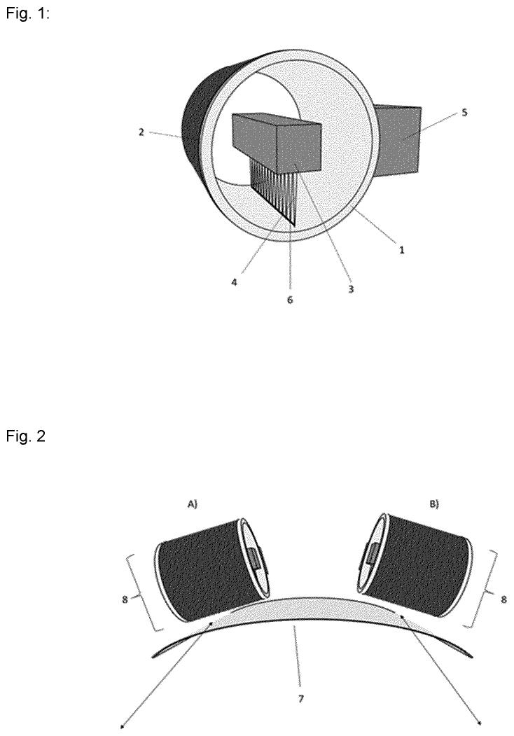

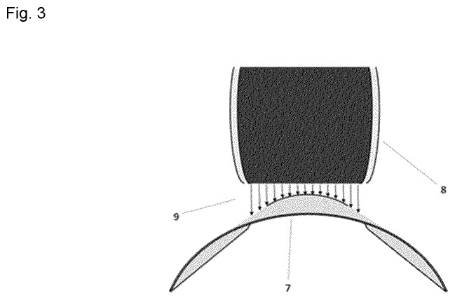

in FIG. 2 a schematic illustration of the spatial controlled printing head and

in FIG. 3 a schematic illustration of printing on a curved substrate.

In the print system according to the drawing typically the following components are relevant:

Ink ribbon, ink, energy beam projector, energy beam, inking unit, writing line, 3D surface, print head and printed ink.

An ink carrier in cylindrical form (1) is completely and seamlessly coated by a specially designed inking unit (5) with the ink (2) to be printed. An energy beam system (3) located in the ink carrier (1) addresses an energy beam (4) in such a way that the energy beam (4) is able to address a closed line (6). Information is printed in such a way that the energy beam (4) is switched on or off simultaneously with the information to be printed, while the energy beam is addressed on the writing line. One or more energy beams (4) can be used for this purpose. The energy beam (4) can be continuously moved (scanned) across the writing line (6) or by using an array the writing line (6) can also be completely addressed in one step and written by the energy beam (4).

The inking unit (5) is thereby able to replace the used ink (2) on the ink carrier (1).

Printing process over a three-dimensional surface:

The print head (8) is moved over a three-dimensional surface (7) in such a way that the total distance between the writing line (6) and the 3d surface (7) is as small as possible but there is no contact between print head (8) and 3d surface (7). The print head (8) is then moved along an axis over the 3d surface (7). Since the total condition can always change during the movement in one axis, the print head (8) must always be tracked by possible movements in all three spatial axes X,Y,Z and possibly by rotation on the spatial axes X,Y,Z.

Nevertheless, the print head (8) can only be optimally adjusted approximately to a deformed 3d surface (7) in this way. Thus, depending on the radius of curvature of the 3d surface (7), the conditions for transferring a homogeneous colour film will always change. To compensate for this, the print head (8) is additionally able to transfer different quantities of ink by changing the intensity of the energy beam (4) along the writing line (6). The transfer of different amounts of ink can also be achieved by directly inking the ink carrier (1) to varying degrees, so that an ink film gradient is created on the surface of the ink carrier (1).

The present invention is additionally illustrated by the following printing example:

A typical formulation for printing according to the present invention is as follows:

about 0.25% high molecular Ethylcellulose
about 3% Polyvinylbutyral (PVB)
about 6% Carbon Black
about 4% Dispersing Additive (e.g. DisperBYK 102)
about 87% Solvent (e.g. Methoxypropanol)

This mixture is then used to coat the print head with a 30-40 μm thick film. The print head is then moved to the substrate at different distances and the laser prints the ink. It is important here to reduce the number of splashes by adding, for example.

Result concerning satellite generating (wet coating thickness is about 30 μm):

| Ethyl- | | | | | | | |
|---|---|---|---|---|---|---|---|
| cellulose | | | | | | | |
| content | Distance | 1 mm | 2 mm | 3 mm | 4 mm | 5 mm | |
| 0.10% | | 123 | 145 | 163 | 178 | 201 | Number of |
| 0.25% | | 34 | 39 | 42 | 53 | 63 | spatters; |
| 0.50% | | 14 | 21 | 27 | 32 | 41 | regarded |
| 0.75% | | 9 | 14 | 19 | 24 | 29 | reference |
| 1% | | 4 | 7 | — | — | — | area 0.1 cm² |

1. A process for printing a substrate containing curved surface sections by using an ink printing assembly comprising a movable print head comprising an ink carrier having an ink layer, the process comprising: regionally irradiating the ink layer in such a way that heat bulges are formed in the ink layer which cause the splitting of ink droplets so that the ink printing assembly is working as a nozzleless droplet ejector for ejecting droplets of ink from the ink layer, wherein
the distance between the movable print head and the curved surface sections of the substrate is adjusted by moving the print head relative to the substrate by providing the print head with three degrees of freedom in translation, allowing horizontal (Tx), vertical (Tg) and in depth (Tz) translations.

2. The process according to claim 1, wherein the ink layer is irradiated by means of a laser.

3. The process according to claim 1, wherein the ink carrier and the ink layer are moved parallel to one another.

4. The process according to claim 1, wherein the movable print head is additionally provided with two degrees of freedom in rotation, which supports and ensures the orientation of the print head by allowing rotations (Rx, Ry) thereof along two perpendicular axes.

5. The process according to claim 2, wherein the laser comprises a switched laser designed as a laser working with a single light wavelength.

6. The process according to claim 2, wherein the ink layer being in contact with the ink carrier is generated with a variable thickness so that the current amount of the ejected ink is adjustable.

7. The process according to claim 2, wherein the current amount of the ejected ink is adjustable by variation of the intensity of the irradiation.

8. The process according to claim 1, wherein the ink layer comprises one or more of absorbing particles and reflective particles, and a soluble polymer having a weight average (Mw) molecular weight of greater than 250 000 g/mol, where the weight average (Mw) of the molecular weight of the soluble polymer is determined according to DIN 55672-2: 2016-3.

9. The process according to claim 8, wherein the soluble polymer has a weight average (Mw) molecular weight of 250 000 g/mol to 2 500 000 g/mol.

10. The process according to claim 8, wherein the proportion of the soluble polymer accounts for between 0.05 to 2 weight %, of the total ink mixture.

11. The process according to claim 8, wherein the absorbing particles comprise carbon black.

12. The process according to claim 1, further comprising drying or thermally curing the ink after printing and/or applying two or more ink layers one above another.

13. (canceled)

14. (canceled)

15. A printing apparatus containing a nozzleless droplet ejector, a movable print head comprising an ink carrier, and an apparatus for moving the movable print head to provide three degrees of freedom in translation, allowing horizontal (Tx), vertical (Tg) and in depth (Tz) translations,
the printing apparatus being configured for executing a process for printing a substrate containing curved surface sections, the process comprising:
regionally irradiating an ink layer on the ink carrier in such a way that heat bulges are formed in the ink layer which cause the splitting of ink droplets so that the nozzleless droplet ejector ejects droplets of ink from the ink layer, wherein
the distance between the movable print head and the curved surface sections of the substrate is adjusted by moving the print head relative to the substrate by providing the print head with the three degrees of freedom in translation.

16. The printing apparatus according to claim 15, wherein the apparatus for moving the print head is robot having an arm connected with the movable print head.

17. The printing apparatus according to claim 15, wherein the apparatus for moving the print head additionally provides two degrees of freedom in rotation, which supports and ensures the orientation of the movable print head by allowing rotations (Rx, Ry) thereof along two perpendicular axes.

18. The process according to claim 1, wherein the ink layer is irradiated by means of a switched laser.

19. The process according to claim 2, wherein the current amount of the ejected ink is adjustable by variation of the laser power.

20. The process according to claim 8, wherein the absorbing particles consist of carbon black.
